(19) United States
(12) Patent Application Publication
(10) Pub. No.: US 2004/0179277 A1
(43) Pub. Date: Sep. 16, 2004

(54) Precisely aligned lens structure and a method for its fabrication

(76) Inventors: Charles R Stallard, Kemp, TX (US); Craig Brooks, Richarsdon, TX (US); John P Schaefer, Plano, TX (US); Joseph F Bochard, McKinney, TX (US); Deurd V Worthen, Richardson, TX (US)

Correspondence Address: Raytheon Company, Bldg EO/E04/N119, P O Box 902, 2000 East El Sugundo Boulevard, El Segundo, CA, 90245-0902, US

(21) Appl. No.: 10/489,565

(22) PCT Filed: Dec. 13, 2002
(86) PCT No.: PCT/US02/39972

(30) Foreign Application Priority Data
Dec. 14, 2001 (US) 60340162

(51) Int. Cl. G02B 7/02

(52) U.S. Cl. 359/811

(57) ABSTRACT

A lens structure includes a nonplastic first lens having a first-lens central optical region lying in the light path, and a first-lens rim between the first-lens central optical region and a first-lens periphery of the first lens. The first-lens rim includes a first-lens mating surface. A nonplastic second lens has a second-lens central optical region lying in the light path, and a second-lens rim between the second-lens central optical region and a second-lens periphery of the second lens. The second-lens rim includes a second-lens first mating surface conformable to the first-lens mating surface and in a facing and contacting relation to the first-lens mating surface. The first lens and the second lens are aligned to within a first-lens/second-lens tolerance of not greater than about 0.00005 inch. The first-lens first mating structure and the second-lens first mating surface may be diamond-point machined to the high tolerances, and then assembled.

This application claims the benefit of U.S. Provisional Application No. 60/340,162, filed Dec. 14, 2001, the disclosure of which is hereby incorporated herein by reference.

This invention relates to a lens structure, and, more particularly, to a lens structure wherein the optical elements are very precisely aligned.

### BACKGROUND OF TE INVENTION

Optical lenses and related optical elements are produced and assembled to form a lens structure. For some applications, the lens structure must have a high mechanical precision and small mechanical tolerances that are desirably maintained even when the temperature is changed by moderate amounts.

In a conventional approach to fabricating a lens structure of high mechanical precision and small tolerances, the lenses are prepared from a glass or ceramic lens material transparent to the wavelengths of interest. The lenses are prepared by any appropriate fabrication technique, which usually includes final machining in the case of lens structures that are required to have high mechanical precision. A housing of sufficient strength to support and protect the lenses is prepared, usually from a metallic alloy. The housing, with mounting attachments for the lenses, is fabricated separately from the lenses by any appropriate fabrication technique, typically numerically controlled machining. The lenses are thereafter individually assembled to the respective mounting attachments on the interior bore of the housing to form the lens structure.

These conventional fabrication techniques permit the lenses of the assembled final lens structure to have mechanical-displacement and angular tolerances on the order of 0.0005-0.0001 inch, but no smaller. Achieving these tolerances requires extraordinary care in the machining of the lenses and the housing. The assembly is performed by highly skilled assembly technicians who use great care to find the optimal arrangements of the various lenses and the housing that minimize the mechanical-displacement and angular errors. In a typical case, the assembly technician carefully positions and often repositions the individual lenses within the cylindrical housing relative to each other and to the housing, until the best positioning is achieved. The elements are then fixed in place.

The final assembly is performed at room temperature. When the finished assembly is used in a service environment that is above or below room temperature, the tolerance errors remaining in the final lens structure often become even greater due to differences in the coefficients of thermal expansion of the lenses and the housing. The result is a variation, and often a degradation, in the mechanical alignment and thence the optical performance of the lens structure as a function of temperature.

The conventional approach is sufficient for many types of optical systems. For others that are now under development, the existing approaches simply do not allow the maintaining of sufficiently small mechanical-displacement and angular tolerances. There is a need for an improved approach to the design, production, and assembly of lens structures, which provides tighter tolerances, both at room temperature and at moderately elevated or reduced temperatures. The present invention fulfills this need, and further provides related advantages.

### SUMMARY OF THE INVENTION

The present invention provides a mechanically precisely aligned lens structure and a method for its fabrication. The lens structure is assembled to a tolerance of not greater than about 0.00005 inch, and typically to a tolerance of not greater than about 0.00001 inch, between the lenses. The alignment tolerance is maintained even with moderate temperature changes, and is not dependent upon the thermal expansion of the housing. The present approach allows the lens structure to be readily assembled with minimal attention to achieving the mechanical alignment.

In accordance with the invention, a method for fabricating a lens structure relative to a light path passing through the lens structure comprises the steps of first preparing a nonplastic first lens having a first-lens central optical region, and a first-lens rim between the first-lens central optical region and a first-lens periphery of the first lens, and first machining a first-lens first mating surface into the first-lens rim. The method includes second preparing a nonplastic second lens having a second-lens central optical region, and a second-lens rim between the second-lens central optical region and a second-lens periphery of the second lens, and second machining a second-lens first mating surface into the second-lens rim. The second-lens first mating surface is conformable to the first-lens first mating surface. The machining steps are preferably performed by precision diamond-point turning. The first lens is assembled to the second lens so that the first-lens first mating surface is in a contacting and facing relation to the second-lens first mating surface.

The material of construction of the lenses should not be a plastic (i.e., organic) material. Plastic lenses, popular in many applications because of their low cost, are not suitable for high-precision applications because they cannot be machined easily and cannot be machined to sufficiently close mechanical tolerances, because the variation between pieces of the nominally same material is too great, because they have coefficients of thermal expansion that are too great, and because their optical properties vary too greatly with temperature changes.

The step of first machining desirably includes the step of first machining the first-lens first mating surface into the first-lens rim to a first-lens-first-mating-surface tolerance of less than about 0.00005 inch. The step of second machining desirably includes the step of second machining the second-lens first mating surface into the second-lens rim to a second-lens-first-mating-surface tolerance of less than about 0.00005 inch. The first lens and the second lens are thus aligned to within a first-lens/second-lens tolerance of not greater than about 0.00005 (and preferably not greater than about 0.00001) inch. These tolerances are determined by the limits of the machining tolerance, and may improve further over time as the machining tolerances improve.

The first-lens first mating surface typically includes a first-lens axial positioning surface oriented at an angle to the light path of less than about 45 degrees, and preferably substantially parallel to the light path, and a first-lens pilot surface oriented at an angle to the light path of more than about 45 degrees, and preferably substantially perpendicular to the light path. Similarly, the second-lens first mating surface includes a second-lens axial positioning surface oriented at an angle to the light path of less than about 45 degrees, and preferably substantially parallel to the light path, and a second-lens pilot surface oriented at an angle to the light path of more than about 45 degrees, and preferably substantially perpendicular to the light path.

The method also may include preparing a housing having an inner wall, and a housing mating surface extending radially inwardly from the inner wall of the housing. A lens-group mating surface is machined on one member of the lens group, such that the housing mating surface is conformable to the lens-group mating surface, and so that the lens group and the housing are aligned to within a lens-group/housing tolerance of not greater than about 0.00005 inch. The step of assembling includes the steps of assembling the lens-group within the housing inner wall such that the housing mating surface is in a facing and contacting relation to the lens-group mating surface, and biasing the lens-group mating surface toward the housing mating surface using a resilient biasing element.

This basic structure of two lenses may be extended to additional lenses directly contacting the first and second lenses, and to additional lenses that are spaced apart from the first and second lenses but fabricated and assembled in a manner in which the highly precise lens structure is achieved for all of the lenses of the lens structure.

In the first case, the step of first machining includes the step of fist machining a first-lens second mating surface oppositely disposed to the first-lens first mating surface. The method further includes third preparing a nonplastic third lens having a third-lens central optical region, and a third-lens rim between the third-lens central optical region and a third-lens periphery of the third lens, and third machining a third-lens first mating surface into the third-lens rim. The third-lens first mating surface is conformable to the first-lens second mating surface. The step of assembling includes the step of assembling the first lens to the third lens so that the first-lens second mating surface is in a contacting and facing relation to the third-lens first mating surface, wherein the first lens and the third lens are aligned to within a first-lens/third-lens tolerance of not greater than about 0.00005 inch, and preferably not greater than about 0.00001 inch.

In the second case, the step of second machining includes the step of second machining a second-lens second mating surface oppositely disposed to the second-lens first mating surface. The method further includes preparing a spacer-tube, and spacer-tube machining into the spacer-tube a spacer-tube first mating surface conformable to the second-lens second mating surface, and a spacer-tube second mating surface oppositely disposed to the spacer-tube first mating surface. The method further includes fourth preparing a nonplastic fourth lens having a fourth-lens central optical region, and a fourth-lens rim between the fourth-lens central optical region and a fourth-lens periphery of the fourth lens, and fourth machining a fourth-lens first mating surface into the fourth-lens rim, wherein the fourth-lens first mating surface is conformable to the spacer-tube second mating surface. The step of assembling includes the steps of assembling the spacer tube to the second lens so that the spacer-tube first mating surface is in a contacting and facing relation to the second-lens second mating surface, and assembling the fourth lens to the spacer tube so that the fourth-lens first mating surface is in a contacting and facing relation to the spacer-tube second mating surface. The spacer tube and the fourth lens are aligned to within a spacer tube/fourth-lens tolerance of not greater than about 0.00005 inch, and preferably not greater than about 0.00001 inch.

A lens structure extending along a light path and comprises a lens group including a nonplastic first lens having a first-lens central optical region lying in the light path, and a first-lens rim between the first-lens central optical region and a first-lens periphery of the first lens and lying out of the light path. The first-lens rim includes a first-lens first mating surface. A nonplastic second lens has a second-lens central optical region lying in the light path, and a second-lens rim between the second-lens central optical region and a second-lens periphery of the second lens and lying out of the light path. The second-lens rim includes a second-lens first mating surface conformable to the first-lens first mating surface and in a facing and contacting relation to the first-lens first mating surface. The first lens and the second lens are aligned to within a first-lens/second-lens tolerance of not greater than about 0.00005 inch. Other features discussed above and elsewhere may be incorporated into this lens structure.

A non-transmissive coating is optionally but preferably applied overlying the contacting portions of the various lenses and the spacer tube that are included in the mating surfaces. This non-transmissive coating prevents stray light from passing through the contacting mating surfaces and entering the light path 26. A radial air-bleed groove may be machined into one or both of the contacting mating surfaces of each pair of contacting elements to allow pressure equalization between the interior of the assembled lens structure and the exterior air pressure. The non-transmissive coating may be applied to the portions of the rim of each lens that do not comprise the mating surfaces, but these surfaces (other than the mating surfaces) are not contacting and preferably have small gaps 212 therebetween so that stray light is not transmitted therethrough to any appreciable degree.

In a conventional high-precision lens structure, the individual lenses are attached directly to the inner wall of the housing. The mechanical alignment of the lenses depends upon the interrelation of each lens to the housing, and upon the material properties of the housing and the relation of the material properties (particularly the coefficients of thermal expansion) of the housing and the lenses. Alignment during assembly of the lens structure is difficult and requires extensive skilled labor. In the present approach, substantially better alignment and resistance to loss of alignment with temperature changes is achieved by the use of machinable, highly stable, nonplastic materials for the lenses, joining the lenses directly to each other (or with an intermediate lens-to-lens spacer using the same materials and the same design-interface principles), and the described approach for positioning the lens elements within the housing. Alignment during assembly is achieved by assembling the lens group, and then placing the lens group into the housing and resiliently biasing it into place.

Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a perspective view of a lens structure;

FIG. 2 is a sectional view of the lens structure of FIG. 1, taken on line 2-2;

FIG. 3 is an exploded sectional view of the lens structure of FIGS. 1 and 2, in the same view as FIG. 2;

FIG. 4 is a perspective view of a grooved embodiment of the first lens; and

FIG. 5 is a block diagram of a preferred method for practicing the invention.

### DETAILED DESCRIPTION OF THE INVENTION

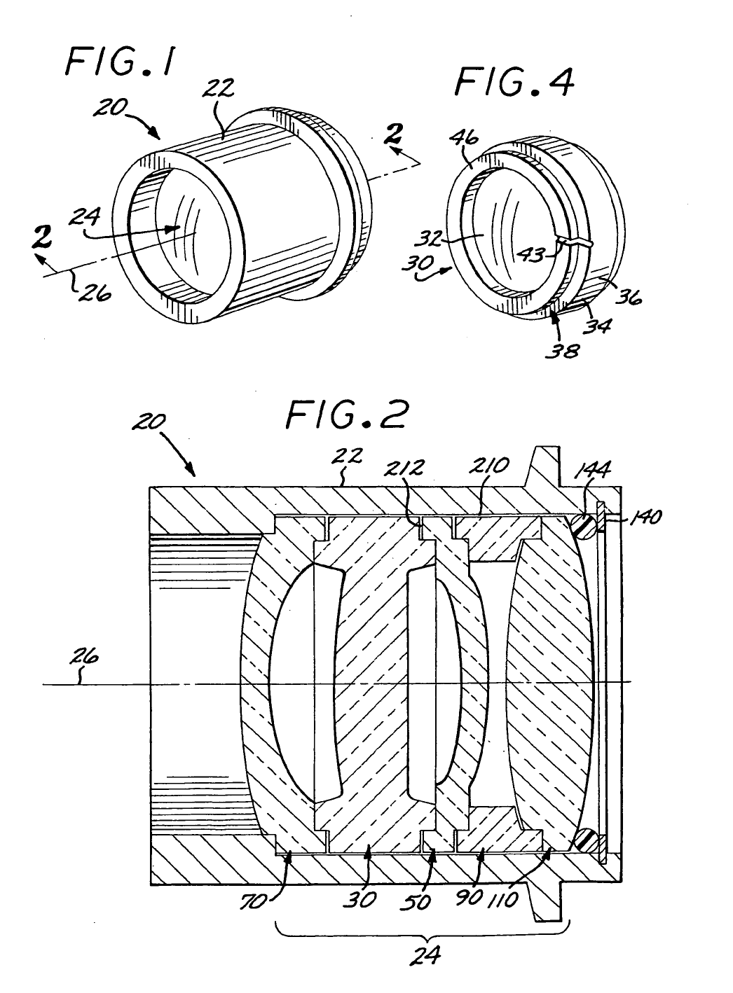

FIG. 1 depicts a lens structure 20 including a housing 22 that contains a lens group 24 therein extending along a light path 26. The lens group 24 is not fully visible in FIG. 1, but may be seen in FIG. 2. In the preferred embodiment, the lens structure 20, the housing 22, and the lens group 24 are generally axisymmetric about the light path 26 (except possibly for incidental features such as a mounting structure on the exterior of the housing 22).

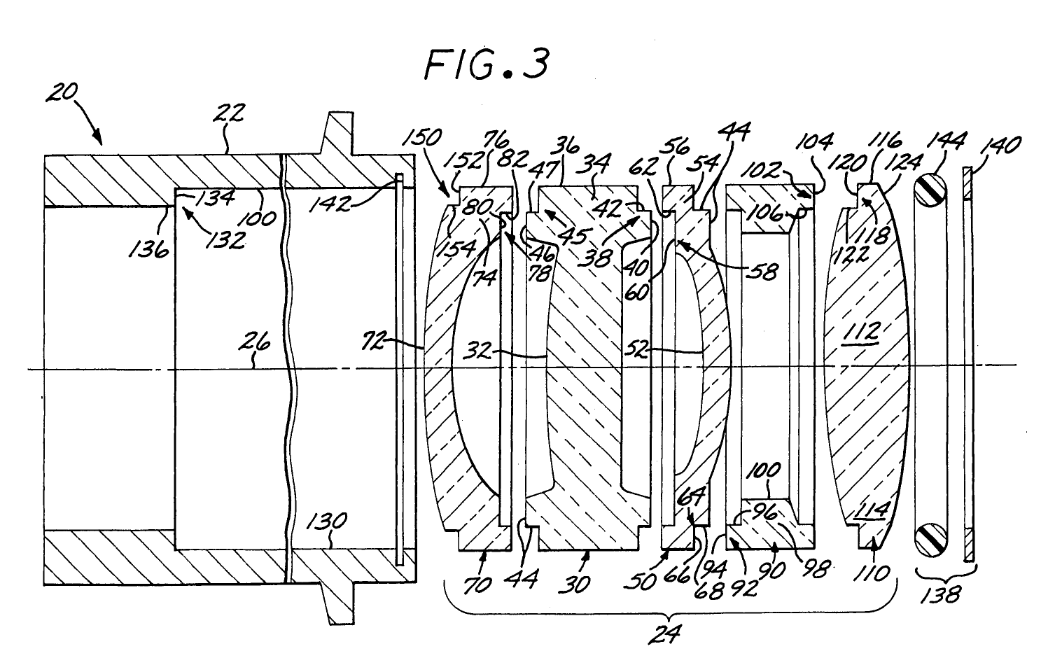

Referring to FIGS. 2 and 3, the lens structure 20 comprises the lens group 24 including a nonplastic first lens 30 of any operable type and shape. (The present discussion of the elements of the lens group does not follow the convention, used in some circumstances, of naming the lens closest to the scene as “lens 1”, the next closest as “lens 2”, and so on.) The first lens 30 has a first-lens central optical region 32 lying in the light path 26, and a first-lens rim 34 between the first-lens central optical region 32 and a first-lens periphery 36 of the first lens 30. As with all of the lenses discussed herein, the central optical region 32 may have any curvature and optical properties in the light path 26. The present approach is not limited by the curvatures and optical properties of the central optical regions of the lenses. The first-lens rim 34 lies radially outwardly from and out of the light path 26. The first-lens rim 34 includes a first-lens first mating surface 38. (As with all of the mating surfaces discussed herein, the first-lens first mating surface 38 preferably extends circumferentially around the rim 34, in the case of an axisymmetric structure.)

The lens structure 20 further includes a nonplastic second lens 50 having a second-lens central optical region 52 lying in the light path 26, and a second-lens rim 54 between the second-lens central optical region 52 and a second-lens periphery 56 of the second lens 50. The second-lens rim 54 lies radially outwardly from and out of the light path 26. The second-lens rim 54 includes a second-lens first mating surface 58 conformable to the first-lens first mating surface 38 and in a facing and contacting relation to the first-lens first mating surface 38.

Preferably, the first-lens first mating surface 38 includes a first-lens axial positioning surface 40 oriented at an angle to the light path 26 of less than about 45 degrees, and a first-lens pilot surface 42 oriented at an angle to the light path 26 of more than about 45 degrees. (Following the usual convention, the angle between a surface and a line is specified from a line perpendicular to, i.e., “normal to”, the surface.) Similarly, the second-lens first mating surface 58 includes a second-lens axial positioning surface 60 oriented at an angle to the light path 26 of less than about 45 degrees, and a second-lens pilot surface 62 oriented at an angle to the light path 26 of more than about 45 degrees. Most preferably, the first-lens axial positioning surface 40 is oriented substantially parallel to the light path 26, and the first-lens pilot surface 42 is oriented substantially perpendicular to the light path 26; and the second-lens axial positioning surface 60 is oriented substantially parallel to the light path 26, and the second-lens pilot surface 62 is oriented substantially perpendicular to the light path 26. (All of the axial positioning surfaces and pilot surfaces discussed herein have the same types of orientations and preferred orientations.) The facing contact between the axial positioning surfaces 40 and 60 positions the lenses 30 and 50 relative to each other parallel to the light path 26. The facing contact between the pilot surfaces 42 and 62 positions the lenses 30 and 50 relative to each other in the radially outward direction perpendicular to the light path 26.

This positioning approach of the lenses 30 and 50 is to be contrasted with the conventional approach. In the conventional approach, each of the lenses is affixed to the housing, so that their positioning and tolerances are determined by the housing and the mode of fixing to the housing. In the present approach, the lenses 30 and 50 are positioned relative to each other by direct contact to each other.

The first lens 30 and the second lens 50 are aligned to each other to within a first-lens/second-lens tolerance of not greater than about 0.00005 inch, and preferably not greater than about 0.00001 inch. This means that the planar mating surfaces of each lens are very accurate and perpendicular to the optical axis generated by the common, DPT machining operation. This also means that the mating pilot diameter of each mating lens is very concentric to each lens optical axis, and therefore each lens optical axis is both concentrically and angularly aligned with the mating lens optical axis. These tolerances cannot be achieved in conventional lens structures.

The concept of “tolerance” in mechanical structures refers to a value of an allowable deviation in a dimension or angle from a specified nominal value, that may not be exceeded. (The “tolerance” is usually considered as a positive or negative variation from a value, and is sometimes stated in terms of a “+/−” number. In the present application, the “+/−” is omitted from the tolerance values and only the absolute value of the tolerance is stated, but the “+/−” is understood to be present.) As the tolerance becomes smaller, the value of the actual dimension or angle, as compared with the nominal dimension or angle, becomes more tightly constrained. It is therefore more difficult to achieve smaller tolerances in mechanical structures. A tolerance of 0.001 inch, for example, is more readily achieved than a tolerance of 0.0001 inch, due to the natural variability of the manufacturing machinery, the nature of the mechanical interface, and the materials of construction. In some optical systems, a tolerance in the alignment of two lenses of 0.001 inch is acceptable, but in other cases that much tolerance from a perfect alignment causes an unacceptably large degradation in performance of the optical system. Thus, although a specified tolerance includes variation of that magnitude or smaller, the specified tolerance does not include a smaller tolerance. More specifically and for example, a tolerance of 0.001 inch does not encompass or make obvious a tolerance of 0.00005 inch, because the mechanical techniques used to obtain the tolerance of 0.001 inch would not lead to a mechanical technique used to obtain the tolerance of 0.00005 inch.

The small tolerance of the present approach is achieved in part by fabricating each of the first-lens first mating surface 38 and the second-lens first mating surface 58 as a machined surface. Most preferably, the mating surfaces 38 and 58 are each a precision diamond-point-turned machined surface. The shape of the optical regions 32 and 42 may be precisely machined by diamond-point turning, and that same approach may be used to machine the mating surfaces 38 and 58. The machining operation will be discussed below in greater detail.

When the first lens 30 and the second lens 50 are assembled together, the fit between the first-lens first mating surface 38 and the second-lens first mating surface 58 is so precise that the volume between the two lenses 30 and 50 is isolated. To allow pressure equilibration between the otherwise-trapped volume and the external pressure, a radially extending air-bleed groove 43 may be cut into either the first-lens first mating surface 38 or the second-lens first mating surface 58, as shown in FIG. 4 for the groove 43 in the first-lens first mating surface 38. Such an air-bleed groove 43, where used, is typically provided between each pair of lenses in the lens group 24.

A problem encountered with the lenses made by the present approach is that the rims 34 and 54, and their respective mating surfaces 38 and 58, become so precisely aligned that they may perform as unintentionally optically transmissive structures that permit stray light to pass into the respective central optical regions 32 and 52. To prevent such intrusion of stray light into the light path 26, a coating 44 that is non-transmissive to light may be applied overlying at least that portion of the rims 34 and 54 that are included in the respective mating surfaces 38 and 58. (Other portions of the rims 34 and 54 do not contact each other, and therefore the transmission of stray light is of much less concern.) The coating 44 serves as a baffle to prevent light passage, but without adding any components between the optical elements that, if present, might interfere with their highly precise alignment. In a preferred case, the coating 44 is vapor-deposited titanium oxide (TiO) in a thickness of about 1000 Angstroms. Such a coating 44 is typically applied over the mating surfaces of the rims of each lens in the lens group 24. The titanium oxide coating has a low transmittance and a desirable low reflectance. The coating 44 could also be a metal, but metals have a higher reflectance. The portions of the lens structure that are not to have the coating 44 applied thereto are masked during the deposition of the coating 44.

In the lens structure 20 of FIGS. 2-3, the first lens 30 further includes a first-lens second mating surface 45 oppositely disposed to the first-lens first mating surface 38. The first-lens second mating surface 45 preferably includes a first-lens second axial positioning surface 46 and a first lens second pilot surface 47, oriented comparably with the respective surfaces 40 and 42. The lens group 24 further includes a nonplastic third lens 70 having a third-lens central optical region 72 lying in the light path 26, and a third-lens rim 74 between the third-lens central optical region 72 and a third-lens periphery 76 of the third lens 70. The third-lens rim 74 lies radially outwardly from and out of the light path 26. The third-lens rim 74 includes a third-lens first mating surface 78 conformable to the first-lens second mating surface 45 and in a facing and contacting relation to the first-lens second mating surface 45. Thus, the third-lens first mating surface 78 preferably includes a third-lens axial positioning surface 80 and a third-lens pilot surface 82. The third-lens axial positioning surface 80 is in a facing and contacting relation with the first-lens second axial positioning surface 46, and the third-lens pilot surface 82 is in a facing and contacting relation with the first-lens second pilot surface 47. The first lens 30 and the third lens 70 are aligned by these contacts to within a first-lens/third-lens tolerance of not greater than about 0.00005 inch, and more preferably about 0.00001 inch.

The spacing between the pairs of lenses 30 and 50, and between the pairs of lenses 30 and 70, may be controlled through the selected length of the respective rims measured parallel to the light path 26, as long as the spacing is not too great. In some cases, however, the lenses must be spaced further apart than is practically achieved by making the rims longer or shorter. In that case, a spacer tube of any required length may be used to increase the spacing between the lenses, and the use of such a spacer tube is illustrated in the lens group 24 of FIGS. 2-3. In this case, the second lens 50 further includes a second-lens second mating surface 64 oppositely disposed to the second-lens first mating surface 58. The second-lens second mating surface 64 preferably includes a second-lens second axial positioning surface 66 and a second-lens second pilot surface 68. The lens group 24 further includes a spacer tube 90 having a spacer-tube first mating surface 92 conformable to the second-lens second mating surface 64 and in a facing and contacting relation to the second-lens second mating surface 64. That is, the spacer-tube first mating surface 92 preferably includes a conforming spacer-tube first axial positioning surface 94 and a spacer-tube first pilot surface 96, conformable and in facing contact with the respective surfaces 66 and 68. The spacer tube 90 has an elongated hollow spacer-tube body 98 with a spacer-tube bore 100 therethrough, so that the light path 26 passes through the bore 100. In the case where there is another lens at the far end of the spacer tube 90 from the second lens 50, a spacer-tube second mating surface 102 is oppositely disposed to the spacer-tube first mating surface 92 at the opposite end of the spacer-tube body 98. The spacer-tube second mating surface 102 preferably includes a spacer-tube second axial positioning surface 104 and a spacer-tube second pilot surface 106. The space tube 90 is included within the lens group 24 even though it is not itself a lens but instead spaces apart two lenses.

The lens group 24 further includes a nonplastic fourth lens 110 having a fourth-lens central optical region 112 lying in the light path 26, and a fourth-lens rim 114 between the fourth-lens central optical region 112 and a fourth-lens periphery 116 of the fourth lens 110. The fourth-lens rim 114 lies radially outwardly from and out of the light path 26. The fourth-lens rim 114 includes a fourth-lens first mating surface 118 conformable to the spacer-tube second mating surface 102 and in a facing and contacting relation to the spacer-tube second mating surface 102. Thus, the fourth-lens first mating surface 118 preferably includes a fourth-lens axial positioning surface 120 and a fourth-lens pilot surface 122. The fourth-lens axial positioning surface 120 is in a facing and contacting relation with the spacer-tube second axial positioning surface 104, and the fourth-lens pilot surface 122 is in a facing and contacting relation with the spacer-tube second pilot surface 106. The spacer tube 90 and the fourth lens 110 are aligned by these and the intervening contacts to within a spacer tube/fourth-lens tolerance of not greater than about 0.00005 inch, and more preferably not greater than about 0.00001 inch.

The various elements 30, 50, 70, 90, and 110 of the lens group 24 may be joined together and mounted by any operable technique. In one approach, an adhesive may be applied to the various mating surfaces before they are contacted together, or the adhesive may be applied externally after the mating surfaces are contacted together. However, it is preferred that adhesive not be used when the required tolerances are extremely small, because the thickness of the adhesive film may not be uniform. A nonuniformity in the adhesive thickness may lead to a wedge effect between the contacting elements that tends to cause an angular misalignment. In another approach in which the elements are non-permanently joined and is preferred because there is no potential for the wedge effect leading to nonuniformity, the mating surfaces may be brought together, and then the housing 22 or an external mechanical clip may be used to hold the lens group 24 together, as described in more detail subsequently.

In the approach that is preferred because it holds the elements of the lens group 24 together, protects the elements, and provides an external attachment for the elements, there is provided the housing 22 having an inner wall 130. A housing mating surface 132 extends radially inwardly from the inner wall 130 of the housing 22 in the manner of an inwardly extending shoulder. The housing mating surface 132 is preferably structured in the same manner as the other mating surfaces discussed herein, with a housing axial positioning surface 134 and a housing pilot surface 136. There is further provided a lens-group mating surface 150 at one end of the lens group 24, in this case on the third rim lens 74 oppositely disposed to the third-lens first mating surface 78. Preferably, the lens-group mating surface 150 has a lens-group axial positioning surface 152 and a lens-group pilot surface 154. The housing mating surface 132 is conformable to the lens-group mating surface 150 and in a facing and contacting relation to the lens-group mating surface 150. The lens group 24 and the housing 22 are aligned to within a lens-group/housing tolerance of not greater than about 0.00005 inch, and preferably not greater than about 0.00001 inch.

A resilient biasing element 138 is disposed at the opposite end of the lens group 24 from the lens-group mating surface 150. The resilient biasing element 138 biases and forces the lens-group 24 and thence the lens-group mating surface 150 toward the housing mating surface 132. The resilient biasing element 138 may be of any type. In the preferred embodiment, the resilient biasing element 138 includes a clip 140 that engages a recess 142 in the inner wall 130 of the housing 22. A resilient elastomeric O-ring 144 lies between the clip 140 and a bevel 124 in the fourth lens rim 114, biasing the fourth lens 110 and thence the lens group 24 toward the housing mating surface 132. The resiliency of the O-ring 144 is sufficient to absorb dimensional changes due to differential thermal expansion between the housing 22 and the lens group 24.

This mode of attaching the housing 22 to the lens group 24 provides important advantages. The individual lenses of the lens group 24 are not directly affixed to the housing 22, and in fact there is a small gap 210 between the lens group 24 and the housing inner wall 130. The differential thermal expansion between the housing 22 and the lenses does not alter the relative spacing between the lenses and does not alter the tolerances in the mechanical orientations between the lenses. The lenses simply change their spacings without altering their orientations and without deforming, which is acceptable in many applications.

The lenses 30, 50, 70, and 110, and the spacer tube 90 are all preferably each unitary in construction (that is, each is made of a single piece of material, but they are not necessarily made from the same starting blank of material). The lenses 30, 50, 70, and 110 are made of a nonplastic material that is transparent to the wavelengths of interest. The preferred nonplastic material for applications in the visible light range is glass, and the preferred nonplastic material for applications in the mid-infrared light range is silicon. Other materials chosen for compatibility with particular wavelength ranges may be used. As discussed earlier, the elements 30, 50, 70, 110, and 90 may not be made of plastic or other organic material. Plastic lenses are used in many applications because of their low cost, but they are not suitable for the present high-precision application because they cannot be machined to sufficiently close mechanical tolerances, because they have coefficients of thermal expansion that are too variable, and because their optical properties vary too greatly with temperature changes. The spacer tube 90 is preferably made of the same material as are the lenses 30, 50, 70, and 110. A different material may be used for the spacer tube 90 in order to achieve particular properties such as a particular coefficient of thermal expansion.

The housing 22 is preferably made of a metal, and most preferably made of a titanium alloy such as Ti—6Al—4V, having a nominal composition of titanium-6 weight percent aluminum-4 weight percent vanadium, because it is machinable by the preferred precision diamond-point turning machining process. Other metals such as nickel alloys, aluminum alloys, beryllium alloys, and other titanium alloys may be used as well.

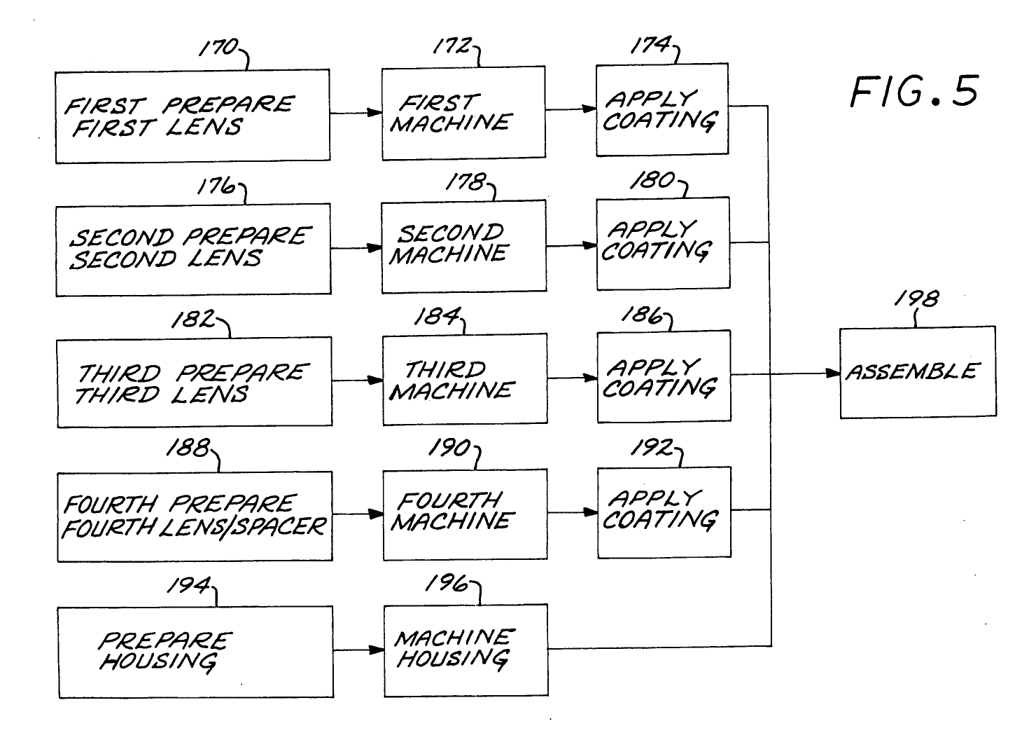

FIG. 5 depicts a preferred approach for fabricating the lens structure 20. The first lens 30 is prepared, numeral 170, and first machined, numeral 172. The second lens 50 is prepared, numeral 176, and second machined, numeral 178. Where used, the third lens 70 is prepared, numeral 182, and third machined, numeral 184. Where used, the fourth lens 110 is prepared, numeral 188, and fourth machined, numeral 190. Where used, the spacer tube 90 is prepared, numeral 188, and fourth machined, numeral 190. The housing, where used, is prepared, numeral 194, and machined, numeral 196. The machining steps 172, 178, 184, and 190 produce the features discussed above for each of the elements of the lens group 24, including both the rim and the optical region in each case. That is, the central optical region of each element (for the lenses) is machined in the same machining setup as the mating surface(s) (i.e., the axial positioning surface(s) and the pilot surface(s)), ensuring that these different portions of each of the lenses and spacers having the desired spatial relationship to each other and the desired tolerances. The machining is preferably performed by precision diamond-point turning, which can achieve the dimensional accuracies required for the tolerances set forth here. Precision diamond-point turning may be performed on nonplastic, hard materials that are candidates for the elements 30, 50, 70, 110, and 90. It is not operable with plastic and other organic materials because they are too soft. It is also not operable with some many metals.

These approaches have been demonstrated to produce tolerances in the lens structure to not greater than about 0.00005 inch, and in many cases to not greater than about 0.00001 inch. The mating surfaces, including the various shaped features discussed herein, and the radial air-bleed grooves 43, where used, are machined as desired in these machining steps.

After the elements are machined, the coatings 44 are applied, numerals 174, 180, 186, and 192, to the desired non-mating-surface portions of the rims of the respective lenses 30, 50, 70, and 110. The coating is preferably accomplished by electron beam vapor deposition, using appropriately shaped masks to prevent deposition on the portions that are not to be coated.

The elements that have been machined and coated where appropriate are assembled together, numeral 198. To perform the assembly, the elements of the lens group 24 are placed with the respective mating surfaces in contact, producing an aligned lens group 24 of very high precision as a result of the precision-machined surfaces. The lens group 24 is inserted into the interior of the housing 22 until the mating surfaces 132 and 150 contact, the O-ring 144 is positioned, and the clip 140 is inserted into the recess 142. The advantages of the simplicity of this assembly approach cannot be overemphasized. In conventional optical structures, the assembly typically requires many hours of labor by a highly skilled optical assembler in trial-and-error procedures that seek to minimize alignment variations. This tedious assembly is avoided by the present approach.

The present invention has been reduced to practice using a lens structure like that shown in FIGS. 2-3 and the method of FIG. 5.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A method for fabricating a lens structure relative to a light path passing through the lens structure, comprising the steps of
first preparing a nonplastic first lens having
a first-lens central optical region, and
a first-lens rim between the first-lens central optical region and a first-lens periphery of the first lens;
first machining a first-lens first mating surface into the first-lens rim;
second preparing a nonplastic second lens having
a second-lens central optical region, and
a second-lens rim between the second-lens central optical region and a second-lens periphery of the second lens;
second machining a second-lens first mating surface into the second-lens rim, wherein the second-lens first mating surface is conformable to the first-lens first mating surface; and
assembling the first lens to the second lens so that the first-lens first mating surface is in a contacting and facing relation to the second-lens first mating surface.

2. The method of claim 1, wherein the steps of first machining and second machining each include the step of
machining by precision diamond-point turning.

3. The method of claim 1, wherein
the step of first machining includes the step of
first machining the first-lens first mating surface into the first-lens rim to a first-lens-first-mating-surface tolerance of less than about 0.00005 inch, and
the step of second machining includes the step of
second machining the second-lens first mating surface into the second-lens rim to a second-lens-first-mating-surface tolerance of less than about 0.00005 inch.

4. The method of claim 1, including an additional step of
applying a non-transmissive coating overlying that portion of the first-lens rim that is included in the first-lens first mating surface.

5. The method of claim 1, wherein
the step of first machining includes the step of
first machining the first-lens first mating surface to include
a first-lens axial positioning surface oriented at an angle to the light path of less than about 45 degrees, and
a first-lens pilot surface oriented at an angle to the light path of more than about 45 degrees, and
the step of second machining includes the step of
second machining the second-lens first mating surface to include
a second-lens axial positioning surface oriented at an angle to the light path of less than about 45 degrees, and
a second-lens pilot surface oriented at an angle to the light path of more than about 45 degrees.

6. The method of claim 1, wherein
the step of first machining includes the step of
first machining the first-lens first mating surface to include
a first-lens axial positioning surface oriented substantially parallel to the light path, and
a first-lens pilot surface oriented substantially perpendicular to the light path, and
the step of second machining includes the step of
second machining the second-lens fist mating surface to include a second-lens axial positioning surface oriented substantially parallel to the light path, and
a second-lens pilot surface oriented substantially perpendicular to the light path.

7. The method of claim 1, wherein the first lens and the second lens are aligned to within a first-lens/second-lens tolerance of not greater than about 0.00005 inch.

8. The method of claim 1, wherein at least one of the steps of first machining and second machining includes the step of
machining a radial air-bleed groove cut into the mating surface being machined.

9. The method of claim 1, further including
preparing a housing having
an inner wall, and
a housing mating surface extending radially inwardly from the inner wall of the housing, and
machining a lens-group mating surface on a lens group comprising the first lens and the second lens, wherein the housing mating surface is conformable to the lens-group mating surface, and
wherein the lens group and the housing are aligned to within a lens-group/housing tolerance of not greater than about 0.00005 inch,
and the step of assembling includes the steps of
assembling the lens-group within the inner wall such that the housing mating surface is in a facing and contacting relation to the lens-group mating surface, and
biasing the lens-group mating surface toward the housing mating surface using a resilient biasing element.

10. The method of claim 1, wherein the step of first machining includes the step of
first machining a first-lens second mating surface oppositely disposed to the first-lens first mating surface, and wherein the method further includes
third preparing a nonplastic third lens having
a third-lens central optical region, and
a third-lens rim between the third-lens central optical region and a third-lens periphery of the third lens, and
third machining a third-lens first mating surface into the third-lens rim, wherein the third-lens first mating surface is conformable to the first-lens second mating surface, and wherein the step of assembling includes the step of
assembling the first lens to the third lens so that the first-lens second mating surface is in a contacting and facing relation to the third-lens first mating surface, and
wherein the first lens and the third lens are aligned to within a first-lens/third-lens tolerance of not greater than about 0.00005 inch.

11. The method of claim 1, wherein the step of second machining includes the step of
second machining a second-lens second mating surface oppositely disposed to the second-lens first mating surface, and wherein the method further includes
preparing a spacer-tube,
spacer-tube machining into the spacer-tube
a spacer-tube first mating surface conformable to the second-lens second mating surface, and
a spacer-tube second mating surface oppositely disposed from the spacer-tube first mating surface, and
fourth preparing a nonplastic fourth lens having
a fourth-lens central optical region, and
a fourth-lens rim between the fourth-lens central optical region and a fourth-lens periphery of the fourth lens, and
fourth machining a fourth-lens first mating surface into the fourth-lens rim, wherein the fourth-lens first mating surface is conformable to the spacer-tube second mating surface,
and wherein the step of assembling includes the steps of
assembling the spacer tube to the second lens so that the spacer-tube first mating surface is in a contacting and facing relation to the second-lens second mating surface, and
assembling the fourth lens to the spacer tube so that the fourth-lens first mating surface is in a contacting and facing relation to the spacer-tube second mating surface.
wherein the spacer tube and the fourth lens are aligned to within a spacer tube/fourth-lens tolerance of not greater than about 0.00005 inch.

12. A lens structure extending along a light path and comprising a lens group including:
a nonplastic first lens having
a first-lens central optical region lying in the light path, and
a first-lens rim between the first-lens central optical region and a first-lens periphery of the first lens and lying out of the light path, the first-lens rim including a first-lens first mating surface; and
a nonplastic second lens having
a second-lens central optical region lying in the light path, and
a second-lens rim between the second-lens central optical region and a second-lens periphery of the second lens and lying out of the light path, the second-lens rim including a second-lens first mating surface conformable to the first-lens first mating surface and in a facing and contacting relation to the first-lens first mating surface,
wherein the first lens and the second lens are aligned to within a first-lens/second-lens tolerance of not greater than about 0.00005 inch.

13. The lens structure of claim 12, wherein the first-lens first mating surface and the second-lens first mating surface are each a machined surface.

14. The lens structure of claim 12, wherein the first-lens first mating surface and the second-lens first mating surface are each a precision diamond-point-turned machined surface.

15. The lens structure of claim 12, wherein the first lens further includes
a non-transmissive coating overlying that portion of the first-lens rim that is included in the first-lens first mating surface.

16. The lens structure of claim 12, wherein
the first-lens first mating surface includes
a first-lens axial positioning surface oriented at an angle to the light path of less than about 45 degrees, and
a first-lens pilot surface oriented at an angle to the light path of more than about 45 degrees, and
the second-lens first mating surface includes
a second-lens axial positioning surface oriented at an angle to the light path of less than about 45 degrees, and
a second-lens pilot surface oriented at an angle to the light path of more than about 45 degrees.

17. The lens structure of claim 12, wherein
the first-lens first mating surface includes
a first-lens axial positioning surface oriented substantially parallel to the light path, and
a first-lens pilot surface oriented substantially perpendicular to the light path, and
the second-lens first mating surface includes
a second-lens axial positioning surface oriented substantially parallel to the light path, and
a second-lens pilot surface oriented substantially perpendicular to the light path.

18. The lens structure of claim 12, wherein the first lens and the second lens are aligned to within a first-lens/second-lens tolerance of not greater than about 0.00001 inch.

19. The lens structure of claim 12, further including
a radial air-bleed groove cut into at least one of the first-lens first mating surface and the second-lens first mating surface.

20. The lens structure of claim 12, further including
a housing having an inner wall,
a housing mating surface extending radially inwardly from the inner wall of the housing,
a lens-group mating surface on the lens group, wherein the housing mating surface is conformable to the lens-group mating surface and in a facing and contacting relation to the lens-group mating surface, and
wherein the lens group and the housing are aligned to within a lens-group/housing tolerance of not greater than about 0.00005 inch, and
a resilient biasing element that forces the lens-group mating surface toward the housing mating surface.

21. The lens structure of claim 12, wherein the first lens further includes
a first-lens second mating surface oppositely disposed to the first-lens first mating surface, and wherein the lens group further includes
a nonplastic third lens having
a third-lens central optical region lying in the light path, and
a third-lens rim between the third-lens central optical region and a third-lens periphery of the third lens and lying out of the light path, the third-lens rim including a third-lens first mating surface conformable to the first-lens second mating surface and in a facing and contacting relation to the first-lens second mating surface, and
wherein the first lens and the third lens are aligned to within a first-lens/third-lens tolerance of not greater than about 0.00005 inch.

22. The lens structure of claim 12, wherein the second lens further includes
a second-lens second mating surface oppositely disposed to the second-lens first mating surface, and wherein the lens group further includes
a spacer tube having
a spacer-tube first mating surface conformable to the second-lens second mating surface and in a facing and contacting relation to the second-lens second mating surface, and
a spacer-tube second mating surface oppositely disposed to the spacer-tube first mating surface, and
a nonplastic fourth lens having
a fourth-lens central optical region lying in the light path, and
a fourth-lens rim between the fourth-lens central optical region and a fourth-lens periphery of the fourth lens and lying out of the light path, the fourth-lens rim including a fourth-lens first mating surface conformable to the spacer-tube second mating surface and in a facing and contacting relation to the spacer-tube second mating surface, and
wherein the spacer tube and the fourth lens are aligned to within a spacer tube/fourth-lens tolerance of not greater than about 0.00005 inch.

23. A lens structure extending along a light path and comprising a lens group including:
a nonplastic first lens having
a first-lens central optical region lying in the light path, and
a first-lens rim between the first-lens central optical region and a first-lens periphery of the first lens and lying out of the light path, the first-lens rim including a first-lens first mating surface and an oppositely disposed first-lens second mating surface;
a nonplastic second lens having
a second-lens central optical region lying in the light path, and
a second-lens rim between the second-lens central optical region and a second-lens periphery of the second lens and lying out of the light path, the second-lens rim including a second-lens first mating surface conformable to the first-lens first mating surface and in a facing and contacting relation to the first-lens first mating surface,
a nonplastic third lens having
a third-lens central optical region lying in the light path, and
a third-lens rim between the third-lens central optical region and a third-lens periphery of the third lens and lying out of the light path, the third-lens rim including a third-lens first mating surface conformable to the first-lens second mating surface and in a facing and contacting relation to the first-lens second mating surface,
wherein the first lens and the third lens are aligned to within a first-lens/third-lens tolerance of not greater than about 0.00005 inch.

24. The lens structure of claim 23, wherein the second lens further includes
a second-lens second mating surface oppositely disposed to the second-lens first mating surface, and wherein the lens group further includes
a spacer tube having
a spacer-tube first mating surface conformable to the second-lens second mating surface and in a facing and contacting relation to the second-lens second mating surface, and
a spacer-tube second mating surface oppositely disposed to the spacer-tube first mating surface, and
a nonplastic fourth lens having
a fourth-lens central optical region lying in the light path, and
a fourth-lens rim between the fourth-lens central optical region and a fourth-lens periphery of the fourth lens and lying out of the light path, the fourth-lens rim including a fourth-lens first mating surface conformable to the spacer-tube second mating surface and in a facing and contacting relation to the spacer-tube second mating surface, and
wherein the spacer tube and the fourth lens are aligned to within a spacer tube/fourth-lens tolerance of not greater than about 0.00005 inch.
